(19) United States
(12) Patent Application Publication
(10) Pub. No.: US 2015/0242915 A1
(43) Pub. Date: Aug. 27, 2015

(54) Used Car Exchange

(71) Applicants: Mark Codiroli, Livermore, CA (US); Anthony V. Bell, JR., Livermore, CA (US)

(72) Inventors: Mark Codiroli, Livermore, CA (US); Anthony V. Bell, JR., Livermore, CA (US)

(21) Appl. No.: 14/185,971

(22) Filed: Feb. 21, 2014

(51) Int. Cl. G06Q 30/06

(52) U.S. Cl. CPC G06Q 30/0613

(57) ABSTRACT

Provided are, among other things, systems, methods and techniques for facilitating inventory exchanges among automobile dealerships. One representative embodiment involves a process of: (a) receiving postings regarding available used cars from automobile dealerships; (b) upon request, displaying the available used car postings to a first one of the automobile dealerships; (c) receiving, from the first one of the automobile dealerships, a purchase offer for an automobile corresponding to a selected one of the displayed used car postings that was posted by a second one of the automobile dealerships; and (d) based on that purchase offer, establishing a requirement that a purchase be made from the available used cars posted by the first one of the automobile dealerships.

### FIELD OF THE INVENTION

The present invention pertains, among other things, to systems, methods and techniques for facilitating exchanges of use-car inventory among automobile dealerships.

### BACKGROUND

Dealers of new automobiles usually also sell used or pre-owned vehicles. Most of these pre-owned vehicles come to the dealer as trade-ins from purchasers of new vehicles. Typically in such transactions, the dealer's main concern is to sell the new car, with the trade-in offer mainly being extended to facilitate the sale. As a result, a dealer's initial inventory of used cars often is not as planned out as would be ideal for the market the dealer serves. Adding to this problem, once a used car has been on the dealer's lot for a long enough period of time, it often can be seen as “stale” inventory—where the salespeople tend to ignore it in favor of more recently added used-car inventory. To address these problems, car dealers often have turned to auctions to rid themselves of their stale or otherwise unwanted inventory.

### SUMMARY OF THE INVENTION

However, the present inventor has determined that several problems exist with this approach. First, there often can be a significant delay until the next auction occurs, during which the unwanted inventory is losing value on an ongoing basis. Second, the costs, in terms of both money and time, associated with auctions often can be fairly high.

The present invention addresses the foregoing problem by providing, among other things, systems, methods and techniques through which car dealers can exchange their unwanted used-car inventories with each other in a more efficient manner. For example, in certain embodiments of the present invention, each commitment by a first dealer to purchase a vehicle from a second dealer's inventory imposes a requirement that the second dealer purchase a vehicle from the first dealer's inventory.

More generally, certain embodiments of the invention are directed to systems, methods and techniques for facilitating inventory exchanges among automobile dealerships. One such representative embodiment involves a process of: (a) receiving postings regarding available used cars from automobile dealerships; (b) upon request, displaying the available used car postings to a first one of the automobile dealerships; (c) receiving, from the first one of the automobile dealerships, a purchase offer for an automobile corresponding to a selected one of the displayed used car postings that was posted by a second one of the automobile dealerships; and (d) based on that purchase offer, establishing a requirement that a purchase be made from the available used cars posted by the first one of the automobile dealerships.

The foregoing summary is intended merely to provide a brief description of certain aspects of the invention. A more complete understanding of the invention can be obtained by referring to the claims and the following detailed description of the preferred embodiments in connection with the accompanying figures.

### BRIEF DESCRIPTION OF THE DRAWINGS

In the following disclosure, the invention is described with reference to the attached drawings. However, it should be understood that the drawings merely depict certain representative and/or exemplary embodiments and features of the present invention and are not intended to limit the scope of the invention in any manner. The following is a brief description of each of the attached drawings.

FIG. 1 is a block diagram of a representative system according to the present invention.

FIG. 2 is a block diagram conceptually illustrating an inventory-swapping technique in accordance with the present invention.

FIG. 3 is a flow diagram illustrating a representative process performed by a server of the present invention.

FIG. 4 is a block diagram illustrating a more generalized inventory-swapping technique of the present invention.

### DESCRIPTION OF THE PREFERRED EMBODIMENT(S)

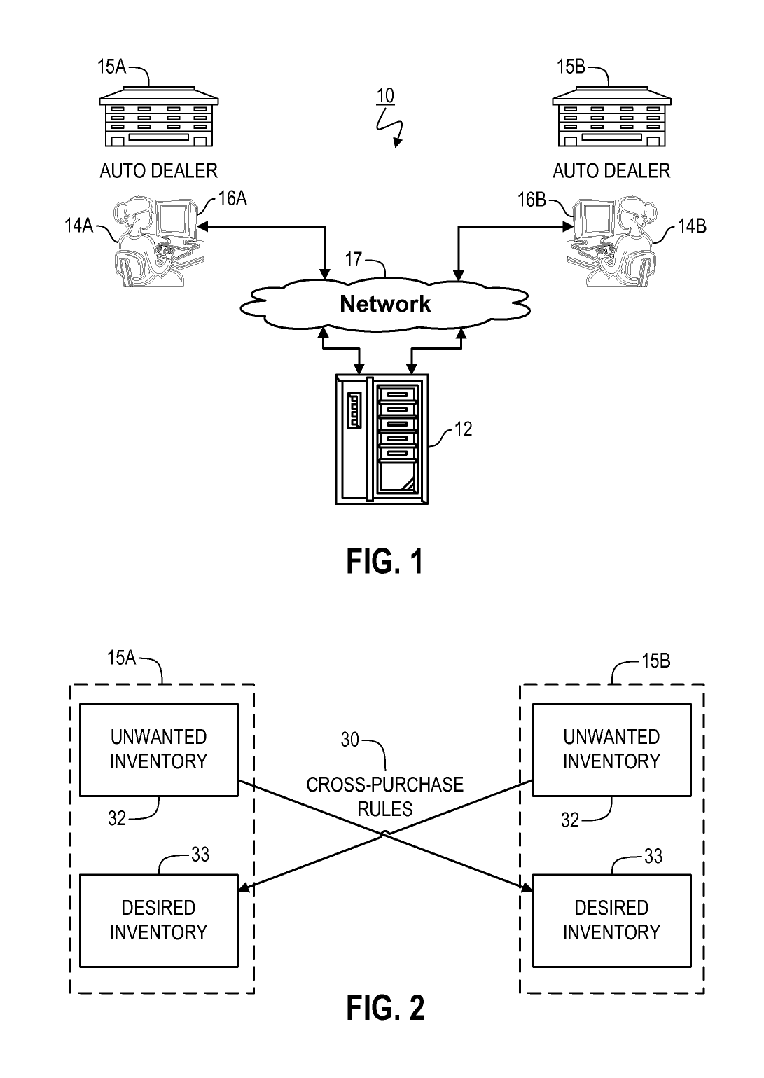

As shown in FIG. 1, a system 10 according to the preferred embodiments of the present invention includes a server 12 that communicates with representatives 14A&B (each generically referred to herein as a representative 14) of different automobile dealerships 15A&B (each generically referred to herein as a dealership 15), respectively, through their respective networked devices 16A&B (each generically referred to herein as a user device 16), across a communications network 17. User devices 16 typically will be desktop or laptop computers, but can be tablet computers, smartphones or any of the type of device.

Although, for ease of illustration, only two dealerships 15 are depicted in FIG. 1, most implementations of system 10 will include at least 5, 10, 20, 50, 100, 200, 500 or even 1,000 dealerships 15, all communicating and entering into transactions with each other through server 12. Of course, due to transportation costs, most transactions typically will occur between dealers that are relatively close to each other, geographically. Similarly, although only a single representative 14 has been depicted for each dealership 15, in fact any number of representatives 14 may communicate with server 12 on behalf of an individual dealership 15.

Typically, communications network 17 includes the Internet, but also (or instead) can include any combination of other networks, such as cellular-based wireless network(s), local area network(s), wide area network(s), Wi-Fi network(s), WiMAX network(s), or even the public switched telephone network (PSTN) or landline telephone network. In the preferred embodiments, server 12 presents the functionality described herein through a website so that user devices 16 can participate in system 10 using just an ordinary web browser. However, server 12 may also (or instead) provide the described functionality through a proprietary user interface that is accessible through a proprietary application (or app) running on a smart phone, tablet or other user device 16. Additional discussion regarding server 12 and user devices 16 is provided below in the section titled “System Environment”.

FIG. 2 illustrates an example of the conceptual operation of system 10. At the heart of system 10 is a set of rules, e.g., rules 30, enforced by server 12, for facilitating exchanges of inventory between different dealerships 15. Each dealership 15 participating in system 10 preferably posts descriptions of its respective unwanted inventory 32 so that such descriptions are viewable by the other dealerships 15 in system 10. In the example shown in FIG. 2, the rules 30 are structured to facilitate single-car exchanges between corresponding pairs of dealerships, so that if a dealership 15A purchases a vehicle from the unwanted inventory 32 of the dealership 15B (typically bringing it into dealership 15A's desired inventory 33), then dealership 15B is required to purchase a vehicle from the unwanted inventory 32 of dealership 15A. Any number of these paired exchanges can be facilitated, each among any two dealerships 15 participating in the system 10.

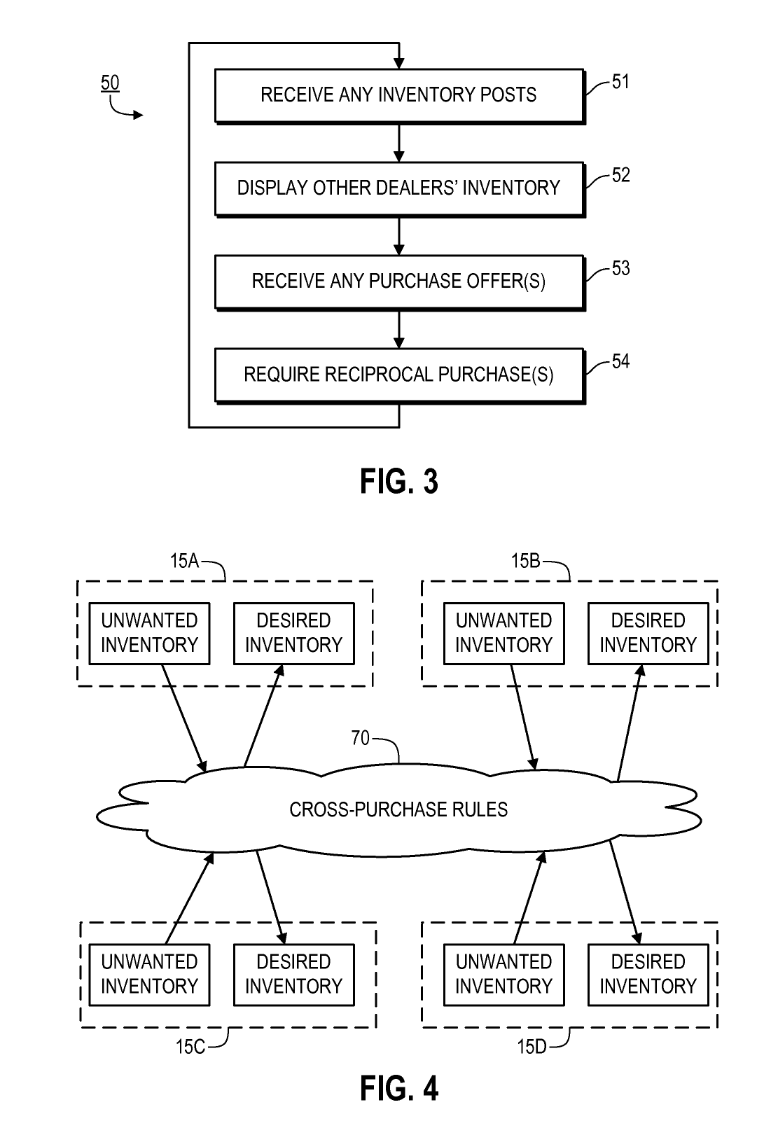

Preferably, server 12 provides the functionality that allows exchanges of vehicles among the dealerships 15 to occur. An example of a process 50 implemented by server 12 is now discussed with primary reference to FIG. 3. Process 50 generally concerns certain interactions between server 12 and one or more user devices 16 associated with a single dealership 15 (referred to in the following discussion as dealership 15A). More specifically, process 50 generally would be executed by server 12 only after an authorized representative 14A of the participant dealership 15A has logged onto the site for system 10 that is being maintained by server 12. Of course, process 50 typically would be repeated multiple times for each dealership 15 participating in the system 10.

Although the steps of a process 50 are illustrated and discussed as occurring in a particular order, the actual order is not critical; instead, such steps can be performed and/or repeated in any desired sequence. Typically, as discussed in greater detail below, the actual sequence of most of the steps of process 50 will be dictated by actions taken by the dealership 15A's representative 14A in navigating the site (e.g., website or the site presented via a proprietary app) provided by server 12, with each step performed in response to the user clicking on a different button, tab or other user interface element included within such site.

Initially, in step 51 server 12 receives any additional inventory information that has been posted by the dealership 15A. Preferably in response to an action by the representative 14A indicating a desire to post information about an additional vehicle owned by the dealership 15A (e.g., clicking on a “list new vehicle” or “modify listing” button or tab), server 12 provides a form (e.g., a web form) for submitting such information. In certain embodiments, such a form includes separate information fields to enter information about the vehicle such as: make, model, year, colors (interior and exterior), included equipment (e.g., original options or after-market add-ons), mileage, condition, accident history and/or geographic location (e.g., for dealerships with more than one location), as well as including functionality for uploading photographs of the vehicle. In the preferred embodiments, at least some of such information is required, e.g., sufficient information to establish a price based on the criteria employed by server 12 (as discussed in greater detail below).

When modifying a previously submitted listing, the current information preferably is pre-populated into the fields and can be changed or supplemented, as desired. In certain embodiments, the dealership 15A's representative 14A also enters the price for the vehicle (preferably determined according to a standard methodology, as discussed below), while in other embodiments server 12 automatically calculates a price based on the information about the vehicle provided by the dealership 15A. In either event, after the representative 14A has entered all available information and clicks on the “submit” button, such information is transmitted from the user device 16A across the network 17 to server 12. Upon receipt, server 12 creates (or modifies, as applicable) a corresponding vehicle record in its database that is associated with the submitting dealership 15A. At this point, the vehicle becomes listed within system 10 as part of the unwanted or available inventory 32 of the submitting dealership 15A. Typically, new car dealers will post their “aged” used car inventory, but any other unwanted inventory 32 may also be posted in this manner. For example, a BMW dealer that has received a used Honda Civic as a trade-in from a recent college graduate might immediately determine, e.g., based on past experience, that its usual customer base probably will not be interested in purchasing a Honda Civic.

In step 52, preferably in response to an action by the representative 14A of dealership 15A indicating a desire to view information regarding vehicles that are available from other dealerships 15 (e.g., clicking on a “view available vehicles” button or tab), server 12 preferably presents a page where the representative 14A can browse and/or search information regarding such vehicles. In the preferred embodiments, the information is displayed in a variety of different formats, such as lists of summary information, with each entry being clickable to retrieve complete information about the corresponding vehicle, and with such complete information being displayed in substantially the same manner it is was entered, so that users have a more consistent user experience. In addition, the representative 14A preferably can search for or narrow down the displayed available vehicles by any of a variety of different criteria, such as: price, type or classification of vehicle, year of vehicle, dealership 15 offering the vehicle, and/or geographic location of vehicle.

In addition to information posted by the offering dealership 15, in some embodiments server 12 also calculates and displays the price at which the vehicle can be purchased. In this regard, the system 10 according to the present invention preferably requires all purchases to be made a price that has been calculated using a standard methodology, formula or benchmark. More preferably, one of the Kelly Blue Book™ values is used (either directly as the list price or some formula based on it is used as the list price, such as some percentage above or below Blue Book value), and the price is calculated for each vehicle by inputting the information submitted by the offering dealership 15 regarding, e.g., make, model, year, mileage, condition, optional equipment and geographic location of the vehicle. However, any other methodology (which can include any single technique or any combination of techniques) that provides a reasonable estimate of value (preferably wholesale value) instead can be used. Some advantages of such automatic price calculation is that it reduces the chance of calculation error, and the price can be automatically updated as the vehicle ages and/or as market conditions change. However, as noted above, in other embodiments, the listing dealerships 15 actually submit the price, but even in these embodiments it is preferred that the dealerships 15 required to determine the submitted price in accordance with the selected standard methodology (e.g., all dealerships 15 are required to list at the selected Blue Book value, such as the Blue Book trade-in value).

In step 53, in response to an action by the representative 14A indicating a desire to acquire an available vehicle (e.g., clicking on a “buy now” button associated with a particular displayed vehicle), a corresponding message (e.g., generated and transmitted by the user's browser) is received from a user device 16A by server 12 over the network 17. In the preferred embodiments, all participating dealerships 15 previously have agreed (e.g., as part of the terms and conditions of using system 10) that the combination of a first dealership 15B posting a vehicle and a second dealership 15A agreeing to purchase it in the foregoing manner constitutes a legally binding agreement between the two parties for the purchase and sale of the vehicle. Accordingly, in response to the foregoing action by representative 14A, server 12 preferably sends electronic notifications or confirmations to both parties regarding the details of the newly entered purchase/sale agreement, and removes the subject automobile record from its database of available vehicles.

From that point forward, depending on the particular embodiment, either: (1) the contracting parties coordinate all aspects of payment for and delivery of the vehicle; or (2) administrators of, or third-party participants in, system 10 provide services to facilitate such payment and delivery. One such service, provided in certain embodiments, is third-party verification of the information that was provided by the listing dealership 15A; in this case, if any discrepancies are found, e.g., such third party may be empowered to adjust the price of the vehicle (e.g., for relatively minor discrepancies) by plugging the correct information into the standard pricing methodology or to completely cancel the transaction (e.g., for substantial discrepancies).

In the preferred embodiments, step 54 is performed automatically in response to step 53. That is, an important aspect of the preferred systems of the invention is a requirement that reciprocal purchases of inventory be made, in accordance with pre-specified cross-purchase rules. In these embodiments, dealerships (such as dealership 15A) are incentivized to purchase vehicles from the unwanted inventory 32 of other dealerships (such as dealership 15B) because they know that such purchases will generate a requirement that another dealership 15 will purchase from their unwanted inventory 32, according to such pre-specified cross-purchase rules (i.e., reciprocal purchase).

Such rules can vary from embodiment to embodiment. However, in the currently preferred embodiments a cross-purchase rule 30 specifies that for each vehicle purchased by a dealership (e.g., dealership 15A) from another dealership (e.g., dealership 15B), the selling dealership 15B is then required to purchase one vehicle from dealership 15A, typically within a set period of time, with both using the same (standard) pricing methodology. In alternate embodiments, the cross-purchase rule 30 is modified to (in at least some cases) take account of the relative prices of the vehicles, e.g., so that purchasing one expensive vehicle might require a reciprocal purchase of a similarly priced vehicle or a reciprocal purchase of two or more lower-priced vehicles. In any event, all transactions preferably are required to occur at prices established using the same standardized pricing methodology.

Preferably, once a requirement for a reciprocal purchase is triggered, the purchase must occur within a specified period of time (e.g., not more than one week, two weeks, one month, 45 days, two months or three months), so that the purchasing dealership 15A can be assured that its unwanted inventory 32 will be reduced shortly after it has made a purchase. However, the dealership 15B from whom the vehicle was purchased by dealership 15A might have difficulty identifying a vehicle in dealership 15A's available inventory 32 that it would like to purchase within that timeframe.

To address this problem, in certain embodiments, server 12 provides a marketplace or virtual trading floor where these reciprocal purchase requirements can be traded among the various participating dealerships 15. Then, if a particular dealership 15B becomes obligated to purchase from the listed inventory 32 of another dealership 15A, it potentially can trade that obligation (in a single trade or a sequence of trades) and obtain in exchange an obligation to purchase from a third dealership 15C (e.g., as shown in FIG. 4) that is listing a vehicle that dealership 15B does in fact want. This additional feature of system 10 sometimes can allow for greater flexibility and efficiency, permitting dealerships 15 to obtain vehicles (from a larger pool of available vehicles) that they believe they are best capable of selling at any given time.

A similar result sometimes can be obtained by dealership 15B actually purchasing a vehicle from dealership 15B (thereby fulfilling its reciprocal purchase requirement) and then immediately relisting that vehicle for sale through system 10 in its own name (i.e., putting it immediately into its unwanted inventory 32). In order to facilitate these types of actions and to avoid unnecessary transportation expenses, in certain embodiments system 10 enforces additional rules, e.g., that require the original dealership 15 to retain physical possession of the vehicle for at least some limited period of time after the purchase by dealership 15B while dealership 15B attempts to sell it to a third dealership 15C.

Similar results also can be obtained by modifying the cross-purchase rules, e.g., to use a set of rules 70 as shown in FIG. 4. The rules 70 do not necessarily require one-to-one cross-purchase agreements. Instead, for example, they can provide for a set of accounts in which: (1) each dealership 15A that purchases a vehicle through system 10 has a right to have one of its vehicles purchased by one of the other participating dealerships 15 (but not necessarily by dealership 15B); and (2) conversely, each dealership 15B from whom a vehicle is purchased is required to purchase a vehicle from one of the other participating dealerships 15 (but not necessarily from dealership 15A). In the course of the various dealerships 15 fulfilling their accrued requirements, many of the earned rights will be satisfied as well.

However, these rights and obligations will not always balance out perfectly, at least within the required timeframes that are acceptable by the various dealerships 15 (i.e., the maximum timeframe in which a reciprocal purchase must occur). Therefore, from time to time, the rules 70 might require the a specific dealership (e.g., dealership 15C) having an (otherwise general) obligation to purchase satisfy that obligation by purchasing from another specified dealership (e.g., dealership 15D) in order to achieve the desired balance (e.g., so that each right to have a vehicle purchased is satisfied within the specified period of time, such as any of the maximum timeframes noted above). Such conversions from general to specific purchase requirements might be specified to occur on a random basis, on a rotating basis, or in any other desired manner, but preferably they take into account geographic distances between the transacting parties.

In any event, as with some of the other approaches mentioned above, by reducing the number of times a given dealership 15B is limited to choosing from the inventory of just one other specific dealership 15A, such rules 70 can often allow for greater choice in selecting which vehicles to purchase. Also, because the rights and requirements according to these rules 70 normally are generalized (i.e., not tied to any particular other dealership 15), when any given dealership 15D has both a right to have one of its vehicles purchased and a requirement to purchase a vehicle, the rules 70 can require or allow such a right and requirement to cancel each other out, either: (1) as a matter of course; (2) whenever any other specified conditions occur; (3) at the discretion of the administrators of system 10; and/or (4) at the election of the dealership 15D that has the right and the requirement. Such cancellations can be used, e.g., to further limit or minimize the number of times when the dealerships 15 (as a group) are required to purchase from just one other dealership 15.

In any event, by facilitating inventory exchanges, the present invention often can significantly reduce the problem of “stale” or otherwise unwanted inventory. For example, any of the reciprocal-purchase rules discussed herein can help ensure that the dealerships 15 are participating more or less equally and using the system as an exchange, rather than resulting in a situation in which too many participants are simply trying to offload their unwanted inventory. Also, by using a “book for book” exchange (or any other standardized pricing methodology), the participating dealerships 15 can be assured that they will pay and receive fair market value for the vehicles they are exchanging.

In the preferred embodiments, dealerships 15 participate in system 10 on a subscription basis, e.g., with different subscription levels corresponding to different monthly fees and different maximum numbers (or other quantities) of monthly exchange transactions.

Typically, a system according to the present invention will be used by new-car dealerships that also sell used cars and want to refresh their existing used-car inventories. However, systems of the present invention also can be used by dealerships that only sell used or pre-owned vehicles. Also, although the present invention has been discussed in terms of exchanging used-car inventory, the systems, methods and techniques described herein can also be applied to any other types of inventory, such as other types of vehicles (e.g., motorcycles, boats, motor homes or trucks), or various types of retail merchandise.

### System Environment.

Generally speaking, except where clearly indicated otherwise, all of the systems, methods, functionality and techniques described herein can be practiced with the use of one or more programmable general-purpose computing devices. Such devices (e.g., including any of the electronic devices mentioned herein) typically will include, for example, at least some of the following components coupled to each other, e.g., via a common bus: (1) one or more central processing units (CPUs); (2) read-only memory (ROM); (3) random access memory (RAM); (4) input/output software and circuitry for interfacing with other devices (e.g., using a hardwired connection, such as a serial port, a parallel port, a USB connection or a FireWire connection, or using a wireless protocol, such as radio-frequency identification (RFID), any other near-field communication (NFC) protocol, Bluetooth or a 802.11 protocol); (5) software and circuitry for connecting to one or more networks, e.g., using a hardwired connection such as an Ethernet card or a wireless protocol, such as code division multiple access (CDMA), global system for mobile communications (GSM), Bluetooth, a 802.11 protocol, or any other cellular-based or non-cellular-based system, which networks, in turn, in many embodiments of the invention, connect to the Internet or to any other networks; (6) a display (such as a cathode ray tube display, a liquid crystal display, an organic light-emitting display, a polymeric light-emitting display or any other thin-film display); (7) other output devices (such as one or more speakers, a headphone set and/or a printer); (8) one or more input devices (such as a mouse, touchpad, tablet, touch-sensitive display or other pointing device, a keyboard, a keypad, a microphone and/or a scanner); (9) a mass storage unit (such as a hard disk drive or a solid-state drive); (10) a real-time clock; (11) a removable storage read/write device (such as a flash drive, any other portable drive that utilizes semiconductor memory, a magnetic disk, a magnetic tape, an opto-magnetic disk, an optical disk, or the like); and/or (12) a modem (e.g., for sending faxes or for connecting to the Internet or to any other computer network). In operation, the process steps to implement the above methods and functionality, to the extent performed by such a general-purpose computer, typically initially are stored in mass storage (e.g., a hard disk or solid-state drive), are downloaded into RAM, and then are executed by the CPU out of RAM. However, in some cases the process steps initially are stored in RAM or ROM and/or are directly executed out of mass storage.

Suitable general-purpose programmable devices for use in implementing the present invention may be obtained from various vendors. In the various embodiments, different types of devices are used depending upon the size and complexity of the tasks. Such devices can include, e.g., mainframe computers, multiprocessor computers, one or more server boxes, workstations, personal (e.g., desktop, laptop, tablet or slate) computers and/or even smaller computers, such as personal digital assistants (PDAs), wireless telephones (e.g., smartphones) or any other programmable appliance or device, whether stand-alone, hard-wired into a network or wirelessly connected to a network.

In addition, although general-purpose programmable devices have been described above, in alternate embodiments one or more special-purpose processors or computers instead (or in addition) are used. In general, it should be noted that, except as expressly noted otherwise, any of the functionality described above can be implemented by a general-purpose processor executing software and/or firmware, by dedicated (e.g., logic-based) hardware, or any combination of these approaches, with the particular implementation being selected based on known engineering tradeoffs. More specifically, where any process and/or functionality described above is implemented in a fixed, predetermined and/or logical manner, it can be accomplished by a processor executing programming (e.g., software or firmware), an appropriate arrangement of logic components (hardware), or any combination of the two, as will be readily appreciated by those skilled in the art. In other words, it is well-understood how to convert logical and/or arithmetic operations into instructions for performing such operations within a processor and/or into logic gate configurations for performing such operations; in fact, compilers typically are available for both kinds of conversions.

It should be understood that the present invention also relates to machine-readable tangible (or non-transitory) media on which are stored software or firmware program instructions (i.e., computer-executable process instructions) for performing the methods and functionality of this invention. Such media include, by way of example, magnetic disks, magnetic tape, optically readable media such as CDs and DVDs, or semiconductor memory such as various types of memory cards, USB flash memory devices, solid-state drives, etc. In each case, the medium may take the form of a portable item such as a miniature disk drive or a small disk, diskette, cassette, cartridge, card, stick etc., or it may take the form of a relatively larger or less-mobile item such as a hard disk drive, ROM or RAM provided in a computer or other device. As used herein, unless clearly noted otherwise, references to computer-executable process steps stored on a computer-readable or machine-readable medium are intended to encompass situations in which such process steps are stored on a single medium, as well as situations in which such process steps are stored across multiple media.

The foregoing description primarily emphasizes electronic computers and devices. However, it should be understood that any other computing or other type of device instead may be used, such as a device utilizing any combination of electronic, optical, biological and chemical processing that is capable of performing basic logical and/or arithmetic operations.

In addition, where the present disclosure refers to a processor, computer, server, server device, computer-readable medium or other storage device, client device, or any other kind of apparatus or device, such references should be understood as encompassing the use of plural such processors, computers, servers, server devices, computer-readable media or other storage devices, client devices, or any other such apparatuses or devices, except to the extent clearly indicated otherwise. For instance, a server generally can (and often will) be implemented using a single device or a cluster of server devices (either local or geographically dispersed), e.g., with appropriate load balancing. Similarly, a server device and a client device often will cooperate in executing the process steps of a complete method, e.g., with each such device having its own storage device(s) storing a portion of such process steps and its own processor(s) executing those process steps. Where the above discussion refers to a “server” such references can apply to a central server (e.g., as is common for most current website hosting) or can refer to a distributed server (e.g., as in the case of a peer-to-peer network where at least some of the server functionality is distributed among many different devices, which typically also function as client devices).

### Additional Considerations.

In certain instances, the foregoing description refers to clicking or double-clicking on user-interface buttons (typically in reference to desktop computers or laptops), touching icons (typically in reference to devices with touchscreens), dragging user-interface items, or otherwise entering commands or information via a particular user-interface element or mechanism and/or in a particular manner. All of such references are intended to be exemplary only, it being understood that each such reference, as well as each other aspect of the present invention as a whole, encompasses entry of commands or information by a user in any of the ways mentioned herein or in any other known manner, using the same or any other user-interface mechanism, with different entry methods and different user-interface elements being most appropriate for different types of devices and/or in different situations. In addition, or instead, any and all references to inputting commands or information should be understood to encompass input by an automated (e.g., computer-executed) process.

In the above discussion, certain methods are explained by breaking them down into steps listed in a particular order. However, it should be noted that in each such case, except to the extent clearly indicated to the contrary or mandated by practical considerations (such as where the results from one step are necessary to perform another), the indicated order is not critical but, instead, that the described steps can be reordered and/or two or more of such steps can be performed concurrently.

References herein to a “criterion”, “multiple criteria”, “condition”, “conditions” or similar words which are intended to trigger, limit, filter or otherwise affect processing steps, other actions, the subjects of processing steps or actions, or any other activity or data, are intended to mean “one or more”, irrespective of whether the singular or the plural form has been used. For instance, any criterion or condition can include any combination (e.g., Boolean combination) of actions, events and/or occurrences (i.e., a multi-part criterion or condition).

Similarly, in the discussion above, functionality sometimes is ascribed to a particular module or component. However, functionality generally may be redistributed as desired among any different modules or components, in some cases completely obviating the need for a particular component or module and/or requiring the addition of new components or modules. The precise distribution of functionality preferably is made according to known engineering tradeoffs, with reference to the specific embodiment of the invention, as will be understood by those skilled in the art.

In the discussions above, the words “include”, “includes”, “including”, and all other forms of the word should not be understood as limiting, but rather any specific items following such words should be understood as being merely exemplary.

Where used above, the terms “require”, “requirement” and similar words are not intended to be used in their strictly absolute sense. Instead, whenever such a term is used, depending upon the particular embodiment, the presently contemplated rules can provide for the referenced “requirement” to be satisfied in other ways, in addition to direct satisfaction. For example, in certain embodiments, a requirement to purchase from one specific dealership 15 might be satisfied by purchasing from a different dealership 15 and paying an additional fee for the added flexibility. However, all such references also contemplate embodiments where only strict satisfaction is permitted.

Several different embodiments of the present invention are described above, with each such embodiment described as including certain features. However, it is intended that the features described in connection with the discussion of any single embodiment are not limited to that embodiment but may be included and/or arranged in various combinations in any of the other embodiments as well, as will be understood by those skilled in the art.

Thus, although the present invention has been described in detail with regard to the exemplary embodiments thereof and accompanying drawings, it should be apparent to those skilled in the art that various adaptations and modifications of the present invention may be accomplished without departing from the spirit and the scope of the invention. Accordingly, the invention is not limited to the precise embodiments shown in the drawings and described above. Rather, it is intended that all such variations not departing from the spirit of the invention are to be considered as within the scope thereof as limited solely by the claims appended hereto.

What is claimed is:

1. A non-transitory medium storing computer-readable, computer-executable process steps for facilitating inventory exchanges among automobile dealerships, wherein said process steps include steps of:
(a) receiving postings regarding available used cars from each of a plurality of automobile dealerships;
(b) upon request, displaying the available used car postings to a first one of the automobile dealerships;
(c) receiving, from the first one of the automobile dealerships, a purchase offer for an automobile corresponding to a selected one of the displayed used car postings that was posted by a second one of the automobile dealerships; and
(d) based on said purchase offer, establishing a requirement that a purchase be made from the available used cars posted by the first one of the automobile dealerships.

2. A non-transitory medium according to claim 1, wherein the requirement is based on a cross-purchase rule that each purchase of an automobile made by a given automobile dealership results in a reciprocal purchase obligation of exactly one automobile from the available used cars that have been posted by said given automobile dealership.

3. A non-transitory medium according to claim 2, wherein the requirement is that the second one of the automobile dealerships is required to purchase exactly one automobile from the available used cars posted by the first one of the automobile dealerships.

4. A non-transitory medium according to claim 1, wherein purchases are made at prices determined in accordance with a fixed methodology based on characteristics of the automobile being purchased.

5. A non-transitory medium according to claim 4, wherein the fixed methodology uses a standard book value of the automobile being purchased.

6. A non-transitory medium according to claim 4, wherein the process steps comprise calculating and displaying the prices using the fixed methodology.

7. A non-transitory medium according to claim 1, wherein the requirement is that second one of the automobile dealerships purchase at least one automobile from the available used cars posted by the first one of the automobile dealerships.

8. A system for facilitating inventory exchanges among automobile dealerships comprising:
a central server; and
a plurality of user devices associated with different automobile dealerships and communicating with the central server over a communications network,
wherein the central server executes a plurality of process steps, including steps of:
(a) receiving postings regarding available used cars from each of a plurality of the automobile dealerships;
(b) upon request, displaying the available used car postings to a first one of the automobile dealerships;
(c) receiving, from the first one of the automobile dealerships, a purchase offer for an automobile corresponding to a selected one of the displayed used car postings that was posted by a second one of the automobile dealerships; and
(d) based on said purchase offer, establishing a requirement that a purchase be made from the available used cars posted by the first one of the automobile dealerships.

9. A system according to claim 8, wherein the requirement is based on a cross-purchase rule that each purchase of an automobile made by a given automobile dealership results in a reciprocal purchase obligation of exactly one automobile from the available used cars that have been posted by said given automobile dealership.

10. A system according to claim 9, wherein the requirement is that the second one of the automobile dealerships is required to purchase exactly one automobile from the available used cars posted by the first one of the automobile dealerships.

11. A system according to claim 8, wherein purchases are made at prices determined in accordance with a fixed methodology based on characteristics of the automobile being purchased.

12. A system according to claim 11, wherein the fixed methodology uses a standard book value of the automobile being purchased.

13. A system according to claim 11, wherein the process steps comprise calculating and displaying the prices using the fixed methodology.

14. A system according to claim 8, wherein the requirement is that second one of the automobile dealerships purchase at least one automobile from the available used cars posted by the first one of the automobile dealerships.
